(19) United States
(12) Patent Application Publication
(10) Pub. No.: US 2026/0330252 A1
(43) Pub. Date: Oct. 22, 2026

(54) MACHINE LEARNING BASED PROACTIVE PREDICTION AND INTERVENTION IN INFORMATION TECHNOLOGY INFRASTRUCTURE

(71) Applicant: Dell Products L.P., Round Rock, TX (US)

(72) Inventors: Tamilarasan Janakiraman, Cork (IE); Karthikeyan Annapillai, Austin, TX (US); Nazeer Ahmed Khan Fazal, Chennai (IN); Sirisha Karnam, Bangalore (IN)

(21) Appl. No.: 19/185,435

(22) Filed: Apr. 22, 2025

(51) Int. Cl. G06N 5/022; G06N 20/00

(52) U.S. Cl. CPC G06N 5/022; G06N 20/00

(57) ABSTRACT

An apparatus maintains data structures characterizing interactions between users of information technology infrastructure, obtains information characterizing an additional interaction, and applies the obtained information to a first machine learning model, wherein the first machine learning model is trained utilizing at least portions of the data structures to predict a particular one of a plurality of possible outcomes for the additional interaction. Responsive to the prediction of the particular outcome, the apparatus triggers a second machine learning model, different than the first machine learning model, to generate one or more communications for delivery to one or more of the devices, the one or more communications providing at least a portion of at least one interventive interaction targeted at achieving an actual outcome that is different than the predicted outcome, and causes the one or more communications to be transmitted to the one or more devices over at least one network.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to machine learning in information processing systems.

### BACKGROUND

Information processing systems comprising information technology (IT) infrastructure may be used to process, compile, store and communicate various types of information, including through the use of artificial intelligence (AI) and other types of machine learning. For example, large language models (LLMs) are a type of AI system that uses machine learning algorithms to process large amounts of natural language text data. LLMs may be used to perform various natural language processing (NLP) tasks, including text classification, text summarization, text generation, named entity recognition, text sentiment analysis, and question answering. Despite the considerable recent advances in AI systems and their associated models, a need remains for further improvements, particularly in terms of automated proactive prediction and intervention in various technology contexts.

### SUMMARY

Illustrative embodiments of the present disclosure provide techniques for machine learning based proactive prediction and intervention in information processing systems comprising IT infrastructure, such as computers, servers, storage devices and other processing devices. For example, some embodiments are configured to automatically predict adverse outcomes that are likely to arise in user interactions involving such devices, and to trigger automated interventions, possibly involving one or more related systems, such as customer relationship management (CRM) systems and/or logistics systems, thereby providing proactive intervention targeted at producing more advantageous actual outcomes. These and other embodiments illustratively utilize machine learning models to automatically trigger generation and delivery of targeted communications, potentially across multiple related systems, to substantially increase the likelihood of successful outcomes. Such arrangements can substantially improve overall productivity in an interaction-based information processing system in which, for example, the interactions correspond to respective potential transactions.

In one embodiment, an apparatus comprises at least one processing device that includes a processor coupled to a memory. The at least one processing device is configured to maintain a plurality of data structures characterizing interactions between users of a plurality of devices in IT infrastructure, to obtain information characterizing an additional interaction between particular ones of the users of at least a subset of the devices in the IT infrastructure, and to apply at least portions of the obtained information characterizing the additional interaction to a first machine learning model, wherein the first machine learning model is trained utilizing at least portions of the data structures to predict a particular one of a plurality of possible outcomes for the additional interaction. The apparatus is additionally configured, responsive to the prediction of the particular outcome, to trigger at least a second machine learning model, different than the first machine learning model, to generate one or more communications for delivery to one or more of the devices, the one or more communications providing at least a portion of at least one interventive interaction targeted at achieving an actual outcome that is different than the predicted outcome. The apparatus is further configured to cause the one or more communications to be transmitted to the one or more devices over at least one network.

Such features of illustrative embodiments are examples only, and should not be viewed as limiting in any way.

These and other illustrative embodiments include, without limitation, additional apparatus, as well as methods, systems and computer program products comprising processor-readable storage media.

### BRIEF DESCRIPTION OF THE DRAWINGS

FIG. 1 is a block diagram of an information processing system configured for machine learning based proactive prediction and intervention in an illustrative embodiment.

FIG. 2 is a flow diagram of an example process for machine learning based proactive prediction and intervention in an illustrative embodiment.

FIGS. 3A through 3C show example pseudocode for implementing aspects of machine learning based proactive prediction and intervention in an illustrative embodiment. These figures are collectively referred to herein as FIG. 3.

FIGS. 4A and 4B show another example process for machine learning based proactive prediction and intervention in an illustrative embodiment. These figures are collectively referred to herein as FIG. 4.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices, in various arrangements of IT infrastructure. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system, such as a cloud-based system that includes one or more private, public and/or hybrid clouds each hosting one or more tenants that access cloud resources.

In some use cases disclosed herein, IT equipment vendors often face order cancellations from enterprises, partners, consumers and other customers, due to a variety of reasons, including changes in customer preferences, configuration mismatches, financial issues and logistical errors. When customers order hardware and/or software products and subsequently cancel, the IT equipment vendor can incur substantial costs for tasks such as initial shipment, logistics, processing and return.

These cancellations not only waste resources but also strain relationships with customers. A significant challenge arises when customers with similar profiles exhibit patterns that lead to cancellations. If one customer cancels orders due to sales-related issues, there is a heightened risk that other customers with similar order behaviors may face the same problems, leading to further cancellations.

Illustrative embodiments disclosed herein address these and other issues by providing a proactive mechanism to predict customer order cancellation insights and enhance efficiency for customer relationships.

For example, some embodiments provide a proactive approach to identify and mitigate risks before they result in order cancellations. Such a proactive approach can substantially increase operational efficiency and profitability for IT equipment vendors, while also improving customer loyalty and trust.

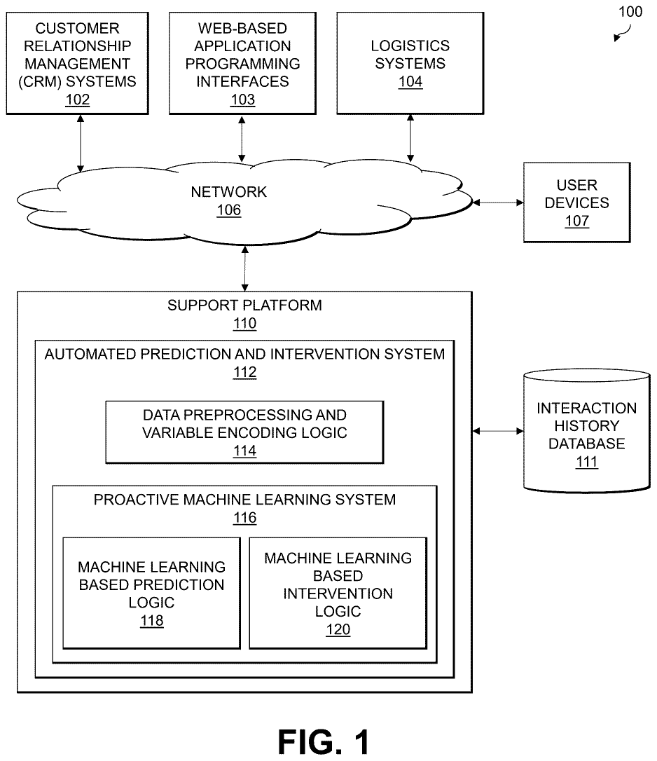

FIG. 1 shows an information processing system 100 configured in accordance with an illustrative embodiment. The information processing system 100 is assumed to be built on at least one processing platform and provides functionality for machine learning based proactive prediction and intervention in IT infrastructure as disclosed herein. The information processing system 100 includes one or more customer relationship management (CRM) systems 102, one or more web-based application programming interfaces (APIs) 103, and one or more logistics systems 104, all coupled to a network 106. Also coupled to the network 106 in the system 100 are one or more sets of user devices 107, and a support platform 110 that has access to an interaction history database 111.

The support platform 110 in the FIG. 1 embodiment is configured to provide automated support services for the users of the system 100, which illustratively include members of an enterprise sales team as well as customers of the enterprise. Such automated support services illustratively include machine learning based proactive prediction and intervention techniques as disclosed herein, which in some embodiments relate to interactions between sales team members and customers carried out via the user devices 107 and illustratively involving one of more of the CRM systems 102, the web-based APIs 103 and the logistics systems 104, although it is to be appreciated that a wide variety of other types of support services can be provided via support platform 110 using additional or alternative arrangements of IT infrastructure in other embodiments.

One or more of the CRM systems 102, the web-based APIs 103, and the logistics systems 104, although shown as being separate from the support platform 110 in the present embodiment, can in other embodiments be deployed at least in part within the support platform 110. Numerous other arrangements are possible.

The support platform 110 illustratively comprises an automated prediction and intervention system 112 that is configured to provide machine learning based proactive prediction and intervention in the system 100. For example, the automated prediction and intervention system 112 in some embodiments is configured to automatically predict adverse outcomes that are likely to arise in user interactions involving the user devices 107, and to trigger automated interventions, possibly involving one or more related systems, such as CRM systems 102, web-based APIs 103 and/or logistics systems 104, thereby providing proactive intervention targeted at producing more advantageous actual outcomes. These and other embodiments illustratively utilize machine learning models to automatically trigger generation and delivery of targeted communications, potentially across multiple related systems, to substantially increase the likelihood of successful outcomes. Such arrangements can substantially improve overall productivity in an interaction-based information processing system such as system 100 in which, for example, the interactions correspond to respective potential transactions.

The term “interaction” as used herein is intended to be broadly construed, and may but need not include bidirectional communication between different users of the system 100. For example, an order or other transaction initiated by one of the users of the system 100 in a manner involving another one of the users of the system 100, is intended to be encompassed by the term “interaction between users” as that term is broadly used herein. Also, a “user” as the term is broadly used herein is not limited to a human user, such as a customer or enterprise sales team member, but can instead include, for example, automated entities of various types, such as hardware and/or software devices of the system 100, including machine learning based components of the system 100. Accordingly, a given “interaction between users of devices” of the system 100 can include, for example, an order or other transaction initiated by a user associated with one of the user devices 107, and possibly involving another user associated with a different one of the user devices 107, and/or involving other system components such as CRM systems 102 and support platform 110.

The automated prediction and intervention system 112 of support platform 110 as shown in FIG. 1 comprises data preprocessing and variable encoding logic 114 and a proactive machine learning system 116. The proactive machine learning system 116 illustratively comprises machine learning based prediction logic 118 and machine learning based intervention logic 120. The machine learning based prediction logic 118 and the machine learning based intervention logic 120 are each assumed to include or to otherwise have access to one or more machine learning models. For example, each of the machine learning based prediction logic 118 and the machine learning based intervention logic 120 may be configured to access one or more machine learning models that are internal to the support platform 110 and/or one or more machine learning models that are external to the support platform 110. The term “machine learning model” as used herein is intended to be broadly construed, and in some embodiments can comprise a combination of multiple distinct machine learning models of different types. Accordingly, some embodiments can be configured to utilize a single composite machine learning model that includes multiple distinct component machine learning models, each configured to implement different types of machine learning functionality within the support platform 110.

In some embodiments, the support platform 110 is used for providing support services for one or more enterprises, illustratively including an enterprise operating or otherwise utilizing the support platform 110. For example, an enterprise may deploy, subscribe to or otherwise utilize the support platform 110 to perform automated prediction and intervention for interactions with customers of that enterprise. The support platform 110 in some embodiments may be operated by or on behalf of a manufacturer and/or vendor of IT infrastructure, so as to provide support services for corresponding hardware and/or software devices of the IT infrastructure, such as computers, servers, storage devices and other processing devices. For example, such a manufacturer and/or vendor can provide the support platform 110 for use by its customers, to facilitate their interaction with the manufacturer and/or vendor of the IT infrastructure.

In some embodiments, the system 100 is implemented at least in part in at least one data center, cloud-based system or other arrangement of multiple networked processing devices, where the term “processing device” as used herein is intended to be broadly construed so as to encompass, for example, computers, servers, switches, storage arrays and/or other processing devices that may be interconnected or otherwise networked with one another within a given information processing system. Such processing devices illustratively comprise various arrangements of hardware processors that execute software programs stored in associated memory in order to implement at least portions of the disclosed functionality.

The user devices 107 may comprise, for example, physical computing devices such as mobile telephones, laptop computers, tablet computers, desktop computers or other types of processing devices, in any combination, that may be utilized by members of an enterprise or other users operating or otherwise associated with the IT infrastructure. At least portions of the user devices 107 may be implemented utilizing virtualized computing resources, such as virtual machines (VMs), containers, etc.

As indicated above, the term “user” herein is intended to be broadly construed so as to encompass numerous arrangements of human, hardware, software or firmware entities, as well as combinations of such entities.

The network 106 is assumed to comprise a global computer network such as the Internet, although other types of networks can be part of the network 106, including a wide area network (WAN), a local area network (LAN), a satellite network, a telephone or cable network, a cellular network, a wireless network such as a WiFi or WiMAX network, or various portions or combinations of these and other types of networks.

The interaction history database 111 is configured to store information that is used by the automated prediction and intervention system 112 in conjunction with machine learning operations of the support platform 110. This information illustratively comprises data records, tables or other types of data structures containing details of previous interactions between users of the system 100, such as transactions or other interactions involving one or more members of an enterprise sales team and one or more customers. Such information in some embodiments can be obtained at least in part from the CRM systems 102, the web-based APIs 103 and/or the logistics systems 104. In other embodiments, the interaction history database 111 may be implemented at least in part with one or more of the CRM systems 102.

The interaction history database 111 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

In some embodiments, such storage systems utilized to implement the interaction history database 111 can be considered part of one or more of the CRM systems 102. Alternatively, although shown as separate from support platform 110 in the figure, the interaction history database 111 and its associated storage system can in some embodiments be implemented at least in part within the support platform 110.

In operation, the automated prediction and intervention system 112 of the support platform 110 is configured to maintain a plurality of data structures characterizing interactions between users of a plurality of devices of the system 100, to obtain information characterizing an additional interaction between particular ones of the users of at least a subset of the devices of the system 100, and to apply at least portions of the obtained information characterizing the additional interaction to a first machine learning model, under the control of the machine learning based prediction logic 118, where the first machine learning model is trained utilizing at least portions of the data structures to predict a particular one of a plurality of possible outcomes for the additional interaction.

The data structures may comprise, for example, data records, tables or other structured arrangements of data, although the term “data structure” as used herein is intended to be broadly construed, and should not be viewed as being limited to these or any other particular types of data structures. A given data structure as that term is broadly used herein can comprise, for example, a portion of a larger data structure or a combination of multiple smaller data structures.

Such data structures are illustratively stored at least in part in the interaction history database 111, the CRM systems 102 and/or in one or more memories or other storage devices of the support platform 110. In some embodiments, the interactions characterized by the data structures comprise respective transactions, such as transactions involving orders of IT equipment from an enterprise sales team, and the data structures include details of the transactions, as described elsewhere herein, including respective corresponding indications of success or failure of the transactions.

Responsive to the prediction of the particular outcome, the automated prediction and intervention system 112 is further configured to trigger at least a second machine learning model, different than the first machine learning model, under the control of the machine learning based intervention logic 120, to generate one or more communications for delivery to one or more of the devices.

The one or more communications illustratively provide at least a portion of at least one interventive interaction targeted at achieving an actual outcome that is different than the predicted outcome, and such communications are caused to be transmitted to one or more devices over the network 106. The one or more devices to which the communications are transmitted may comprise, for example, one or more of the CRM systems 102, the web-based APIs 103, the logistics systems 104 and/or the user devices 107.

The one or more communications can comprise at least portions of one or more emails, texts, chat entries, screen pop-ups and/or other messages. In some embodiments, the one or more communications are generated by the second machine learning model, illustratively utilizing generative AI techniques, as respective questions, statements or other sets of one or more conversational elements that may be incorporated into one or more emails, texts, chat entries, screen pop-ups and/or other messages. The term “communication” as used herein is therefore intended to be broadly construed, so as to encompass, for example, at least a portion of at least one email, text, chat entry, screen pop-up and/or other message.

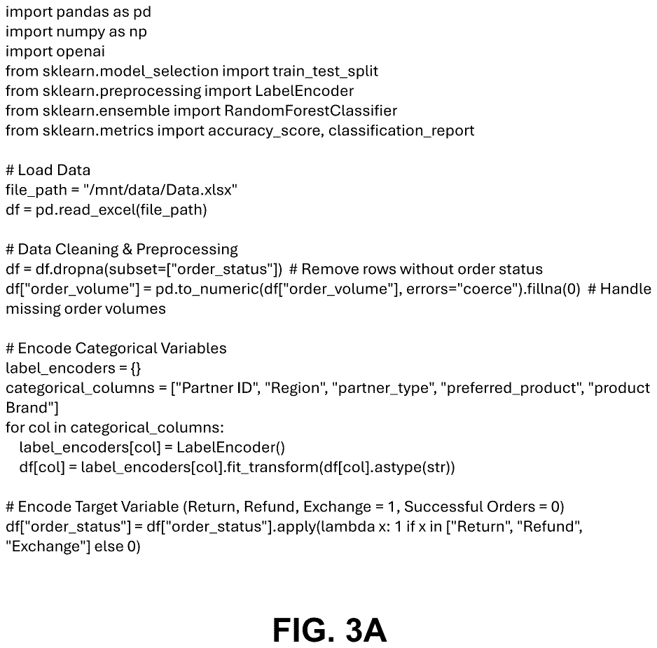

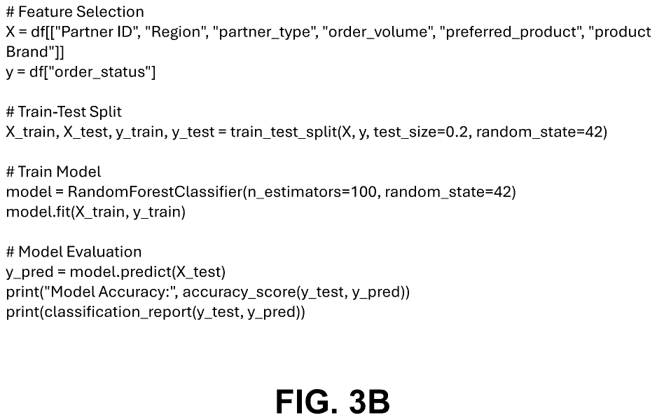

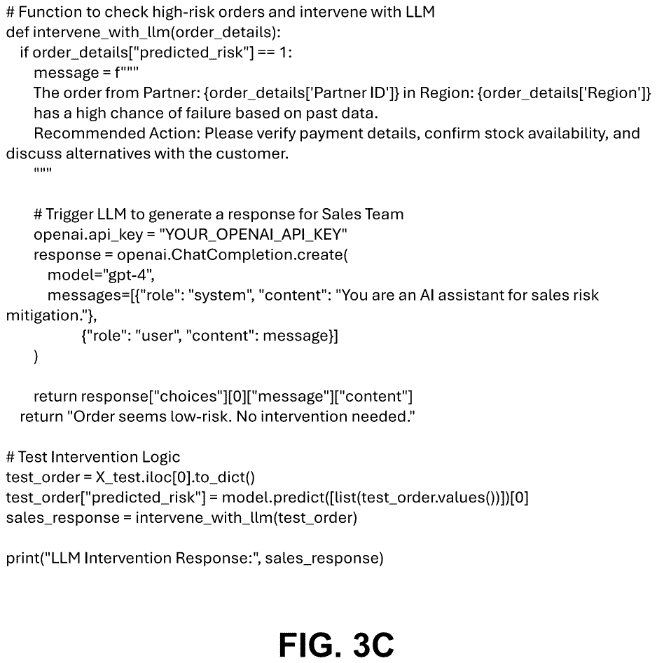

In some embodiments, the first machine learning model comprises at least a random forest classifier, and the second machine learning model comprises a generative AI model including at least one large language model (LLM). More detailed examples of such models are provided in the pseudocode of FIG. 3. Other types and arrangements of additional or alternative machine learning models can be used in other embodiments. For example, various types of gradient boosting models may be used in addition to or in place of a random forest classifier.

In some embodiments, triggering the second machine learning model comprises accessing a web-based instance of the second machine learning model via an API, such as one of the web-based APIs 103. For example, accessing the web-based instance of the second machine learning model via the API illustratively comprises providing the web-based instance of the second machine learning model with an API key, a model version identifier and one or more role designations for the second machine learning model. Other techniques can be used to trigger the second machine learning model to generate one or more communications in other embodiments.

The one or more communications generated by the second machine learning model in some embodiments include one or more messages comprising content generated by the second machine learning model in accordance with at least one role designated based at least in part on the particular outcome predicted by the first machine learning model.

The second machine learning model in some embodiments therefore comprises one or more generative AI models. Such generative AI models can be configured, for example, to generate outputs providing at least portions of an interventive interaction involving one or more users of the system 100.

In some embodiments, the automated prediction and intervention system 112 is further configured to perform at least one test of the interventive interaction utilizing the first machine learning model, prior to causing the one or more communications to be transmitted to the one or more devices over the network 106. In such an embodiment, the one or more communications are transmitted to the one or more devices responsive to the at least one test of the interventive interaction resulting in a test outcome that is different than the predicted outcome.

The one or more communications in some embodiments comprise at least one communication directed to a given one of the CRM systems 102 that triggers the given CRM system to perform a particular operation as part of the interventive interaction.

Additionally or alternatively, the one or more communications in some embodiments comprise at least one communication directed to a given one of the logistics systems 104 that triggers the given logistics system to perform a particular operation as part of the interventive interaction.

These and other automated actions referred to herein are examples of at least portions of what are more generally referred to herein as “interventive interactions” involving one or more system users. Additional or alternative automated actions can be used in other embodiments, and can include, for example, automated generation of alerts, control signals or other communications of various types within the system 100. Such automated actions are illustratively initiated, triggered or otherwise controlled at least in part by the machine learning based intervention logic 120 of the proactive machine learning system 116. A wide variety of other types of automated actions can be performed in other embodiments.

In some embodiments, the additional interaction relates to a particular transaction, such as an order for IT equipment, submitted by a customer to a member of an enterprise sales team, and the particular outcome comprises an indication that the particular transaction has an above-threshold probability of failure.

The automated prediction and intervention system 112 in some embodiments is further configured to determine the actual outcome for the additional interaction based at least in part on the at least one interventive interaction, and to update the first machine learning model utilizing the actual outcome and the at least one interventive interaction. Accordingly, in some embodiments, the first machine learning model is retrained based at least in part on an actual outcome that is achieved via at least one interventive interaction, where the actual outcome is different than the predicted outcome.

Additional examples of illustrative automated prediction and intervention arrangements of the type described above will now be presented. One or more of these aspects are illustratively implemented in the automated prediction and intervention system 112 of the support platform 110 in illustrative embodiments.

As mentioned previously, in some use cases disclosed herein, IT equipment vendors often face order cancellations from enterprises, partners, consumers and other customers, due to a variety of reasons, including changes in customer preferences, configuration mismatches, financial issues and logistical errors. When customers order hardware and/or software products and subsequently cancel, the IT equipment vendor can incur substantial costs for tasks such as initial shipment, logistics, processing and return.

As indicated above, these cancellations not only waste resources but also strain relationships with customers. A significant challenge arises when customers with similar profiles exhibit patterns that lead to cancellations. If one customer cancels orders due to sales-related issues, there is a heightened risk that other customers with similar order behaviors may face the same problems, leading to further cancellations.

Some embodiments address the above-described challenge by implementing system 100 as a machine learning based information processing system that is configured to perform operations such as one or more of the following.
1. Match customers with similar profiles by analyzing their order patterns, preferences, and historical behavior.
2. Predict the likelihood of order cancellations by comparing these profiles and identifying customers at high risk based on historical data.
3. Proactively engage with an IT equipment vendor sales team to intervene before an order is placed or finalized, thereby reducing the chances of cancellation.

The system 100 in some embodiments integrates machine learning to classify customers and predict cancellations. It also introduces a pre-emptive sales intervention step where sales representatives engage with customers identified as high risk, addressing potential issues before they lead to order cancellations.

It should be noted that the term “customer” as used herein is intended to be broadly construed, so as to encompass, for example, an enterprise, a partner, a consumer and/or other entities that purchase hardware and/or software products from an IT equipment vendor. Similarly, the term “IT equipment vendor” is also intended to be broadly construed, and should not be viewed as being limited to any particular type or types of vendors.

In some embodiments, customer profile matching uses data on customers, taken from interaction history database 111 and/or CRM systems 102, to create detailed customer profiles, including attributes such as:
Partner ID
Geographic Region
Industry
Order Volume
Order Value
Product Preferences
Sales Channel
Payment Terms
Past Cancellations
Cancellation Reasons

Using machine learning algorithms like K-means clustering, the system 100 in some embodiments is configured to group customers with similar characteristics and behaviors into clusters. Customers within the same cluster will be considered similar, and their order patterns will be analyzed for common issues, particularly focusing on sales-related cancellations.

Once customers are grouped into clusters, the system 100 is illustratively configured to analyze historical cancellation data to predict the likelihood of future cancellations for each customer. In some embodiments, this illustratively involves training a machine learning model using historical data that includes order details, customer profiles, and cancellation reasons. Machine learning models such as random forest classifiers and/or Gradient Boosting Machines (GBMs) can be used, for example, to predict the probability of an order being cancelled.

Some embodiments are configured to identify high-risk orders based on patterns observed in similar customers. If a customer's profile matches that of another customer with a history of cancellations, the system flags new orders as high risk.

Pre-emptive sales intervention is implemented in some embodiments in the following manner. When an order is flagged as high risk, an alert is sent to the sales team, prompting them to engage with the customer. Specific questions and checks are suggested by the system, tailored to the identified risks (e.g., configuration issues, incorrect shipping addresses, pricing problems, etc.). Additionally or alternatively, guided order modification is provided, where the sales team can help the customer adjust the order to reduce the risk of cancellation.

Some embodiments further implement continuous learning functionality. For example, the system 100 in some embodiments illustratively includes a feedback loop where the outcomes of flagged orders are tracked. Successful interventions lead to model improvements, while cancellations despite intervention help refine the machine learning prediction algorithms. Such embodiments illustratively compute at least one of a utilization score, derived from in-band network analysis (e.g., CPU and memory), to gauge the current server load, and/or a reliability score, obtained from out-of-band network analysis, possibly utilizing a Redfish API or other API for overall system health.

Some embodiments include one or more of the following advantageous features:
1. Cross-customer Pattern Matching. An innovative aspect of this solution lies in its ability to match customers with similar profiles and analyze their behavior to predict potential risks. This goes beyond traditional single-customer assessments by leveraging data from across the customer ecosystem.
2. Targeted Sales Interventions. The introduction of customized interventions based on historical data and pattern matching is a unique approach. It ensures that sales teams address specific, known risks rather than applying generic solutions.
3. Advanced Machine Learning Integration. Using machine learning to predict cancellations and recommend interventions is a novel application of technology in sales and order management. The continuous learning aspect ensures that the system becomes more accurate and effective over time.
4. Comprehensive Risk Assessment. The solution provides a holistic view of risks by considering multiple factors, including technical, financial, and sales-related data points. This comprehensive approach is more effective than addressing individual issues in isolation.

An example illustrating the operation of a predictive mechanism as disclosed herein will now be described.

### Step 1: Order Placement

A customer places a new order for products from an IT equipment vendor. The system immediately analyzes the order details, comparing them against the customer's profile and similar profiles within its cluster.

### Step 2: Risk Assessment

The machine learning model evaluates the risk of cancellation based on historical data. If the customer belongs to a cluster with a history of sales-related cancellations, the order is flagged as high risk.

### Step 3: Sales Intervention

An alert is generated for the sales team, providing them with specific guidance on what to check or confirm with the customer. For example, if configuration mismatches are a common issue, the system suggests verifying the product specifications with the customer.

### Step 4: Engagement and Resolution

The sales team engages with the customer, addressing the identified risks. This may involve adjusting the order, clarifying configurations, or confirming shipping details. The goal is to resolve potential issues before the order is finalized.

### Step 5: Order Finalization

Once the issues are resolved, the order is finalized and proceeds without the risk of cancellation. The system logs the outcome, updating its predictive model based on the success or failure of the intervention.

### Step 6: Continuous Learning

The machine learning model is continuously updated based on new data, improving its ability to predict risks and suggest effective interventions. This ensures that the system remains relevant and increasingly accurate as more data is collected.

These and other illustrative embodiments provide significant advantages over conventional practice. For example, one or more such embodiments overcome significant drawbacks of conventional approaches. Such conventional approaches generally do not proactively address the typical issues, and lack proactive prediction. As such, these conventional approaches are reactive rather than preventative, and fail to proactively engage with customers to resolve potential issues before they lead to cancellations, impacting both customer experience and retention.

Some embodiments disclosed herein provide proactive cancellation prevention. By predicting and addressing potential cancellations before they happen, a system as disclosed herein can significantly reduce the number of failed transactions. This saves resources and reduces the logistical and financial impact of cancellations.

Additionally or alternatively, some embodiments provide enhanced customer relationships. Proactively engaging with customers before problems arise helps build trust and strengthens relationships. Customers and customers will appreciate the added attention to detail and the reduction in order-related issues.

Moreover, some embodiments provide enhanced operational efficiency. Identifying and mitigating risks early leads to smoother operations. Fewer cancellations mean less time and money spent on problem-solving and managing returns or restocking.

Illustrative embodiments disclosed herein advantageously provide data-driven insights. The support platform 110 of system 100 in some embodiments leverages data to make informed decisions, improving the accuracy of predictions over time and enhancing overall decision-making in the sales process.

These and other features and advantages of illustrative embodiments as disclosed herein are presented by way of example only, and should not be viewed as limiting in any way. For example, other embodiments need not provide one or more of the features and/or advantages described above and elsewhere herein.

The support platform 110 in the FIG. 1 embodiment is assumed to be implemented using at least one processing device. Such processing devices can illustratively include particular arrangements of computing, storage and network resources. Each such processing device generally comprises at least one processor and an associated memory, and implements at least portions of one or more functional modules or other logic for controlling certain features of the support platform 110 as disclosed herein.

Accordingly, at least portions of the automated prediction and intervention system 112 of the support platform 110 may be implemented at least in part in the form of software that is stored in at least one memory and executed by at least one processor.

The support platform 110 and other portions of the information processing system 100 may be implemented using at least one processing platform comprising one or more processing devices each having a processor coupled to a memory. Such a processing platform can be implemented in cloud infrastructure or as part of an enterprise system.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the CRM systems 102, the web-based APIs 103, the logistics systems 104, the support platform 110 and the interaction history database 111, or portions or components thereof, to reside in different data centers in different geographic locations. Numerous other distributed implementations are possible. The support platform 110 itself can also be implemented in a distributed manner across multiple data centers.

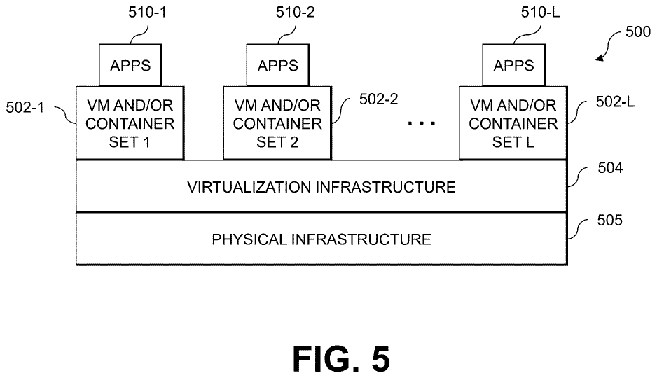

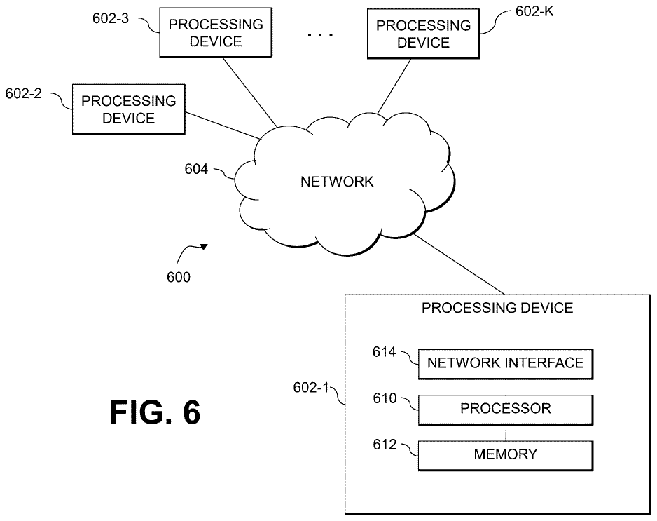

Additional examples of processing platforms utilized to implement the support platform 110 and other components of the information processing system 100 in illustrative embodiments will be described in more detail below in conjunction with FIGS. 5 and 6.

In some embodiments, a processing platform provides compute, storage and network resources to users under a Platform-as-a-Service (PaaS) model, an Infrastructure-as-a-Service (IaaS) model, a Storage-as-a-Service (SaaS) model and/or a Function-as-a-Service (FaaS) model, although it is to be appreciated that numerous other at least partially cloud-based infrastructure arrangements could be used. Also, illustrative embodiments can be implemented outside of the cloud infrastructure context, as in the case of a stand-alone computing and storage system implemented within a given enterprise. Combinations of cloud and edge infrastructure can also be used in implementing a given information processing system to provide support services to users as disclosed herein.

It is to be appreciated that the particular arrangement of system components including the CRM systems 102, web-based APIs 103, logistics systems 104, network 106, user devices 107, support platform 110 and interaction history database 111, as illustrated in the FIG. 1 embodiment, is presented by way of example only, and a wide variety of alternative arrangements can be used in other embodiments. For example, at least portions of the CRM systems 102, web-based APIs 103, logistics systems 104 and/or interaction history database 111 in some embodiments may be deployed within the support platform 110, rather than separate from the support platform 110 as shown in the figure.

Also, other embodiments may include additional or alternative systems, devices and other network entities, as well as different arrangements of modules and other components. It is therefore to be appreciated that these and other features of FIG. 1 and other illustrative embodiments disclosed herein are presented by way of example only, and should not be construed as limiting in any way.

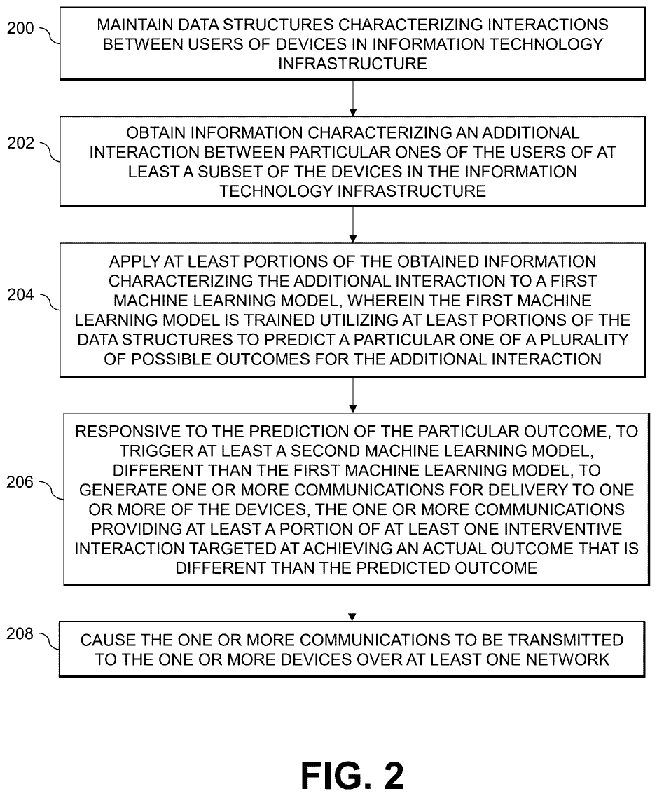

An exemplary process for machine learning based proactive prediction and intervention will now be described in more detail with reference to the flow diagram of FIG. 2. It is to be understood that this particular process is only an example, and that additional or alternative processes for machine learning based proactive prediction and intervention may be used in other embodiments.

In this embodiment, the example process includes steps 200 through 208. These steps are assumed to be performed by the support platform 110 utilizing the automated prediction and intervention system 112, including the data preprocessing and variable encoding logic 114 and the proactive machine learning system 116 comprising machine learning based prediction logic 118 and machine learning based intervention logic 120, as well as multiple associated machine learning models that may include one or more machine learning models internal to the support platform 110 and/or one or more machine learning models external to the support platform 110. Similar processes may be performed utilizing additional or alternative system components in other embodiments.

In step 200, data structures are maintained characterizing interactions between users of devices in IT infrastructure. Such data structures are illustratively maintained, for example, in the interaction history database 111 and/or in other system components such as the CRM systems 102. Additionally or alternatively, such data structures may be maintained at least in part within one or more memories or other storage devices of the support platform 110.

In step 202, information is obtained characterizing an additional interaction between particular ones of the users of at least a subset of the devices in the IT infrastructure. For example, the interactions characterized by the data structures illustratively correspond to orders for IT equipment or other types of transactions involving IT equipment or other IT infrastructure, each of which has reached a particular level of resolution, so as to be characterized as either a successful transaction or a failed transaction, and the additional transaction illustratively comprises a new order that has not yet been fully processed by the system 100 so as to reach the particular level of resolution. Accordingly, the interactions characterized by the data structures may correspond to “completed” transactions that have successfully closed, as well as other transactions that have been canceled or otherwise failed without being successfully closed. The additional interaction may correspond to a “pending” transaction that has not closed and can therefore still be brought to a successful conclusion.

In step 204, at least portions of the obtained information characterizing the additional interaction are applied to a first machine learning model. The first machine learning model is trained utilizing at least portions of the data structures to predict a particular one of a plurality of possible outcomes for the additional interaction. For example, the first machine learning model can predict, based at least in part on its training using previous successful transactions and previous failed transactions, whether or not the additional interaction has an above-threshold likelihood of failure.

In step 206, responsive to the prediction of the particular outcome, at least a second machine learning model, different than the first machine learning model, is accessed, activated or otherwise triggered to generate one or more communications for delivery to one or more of the devices. The one or more communications generated by the second machine learning model provide at least a portion of at least one interventive interaction targeted at achieving an actual outcome that is different than the predicted outcome. Examples of such interventive interactions are described in more detail elsewhere herein.

In step 208, the one or more communications generated by the second machine learning model are caused to be transmitted to the one or more devices over at least one network. For example, the one or more communications may be transmitted to a user device of a member of the enterprise sales team, to a user device of a customer and/or to one or more of the CRM systems 102, web-based APIs 103 and logistics systems 104.

The process comprising steps 200 through 208 can be repeated for one or more additional sets of interactions. Additionally or alternatively, different instances of the process can operate at least in part in parallel with one another in processing different sets of interactions, illustratively involving different sets of users.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

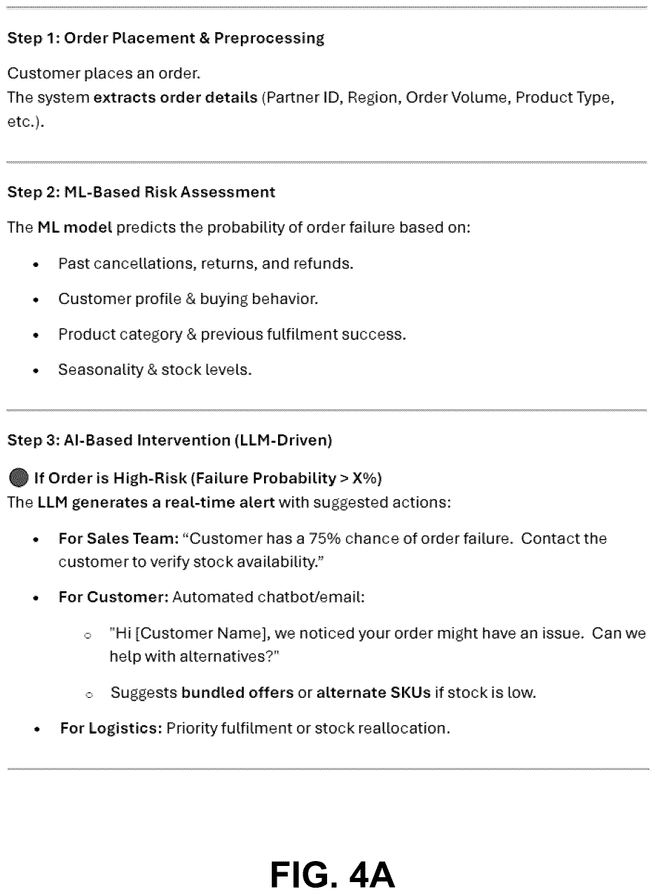

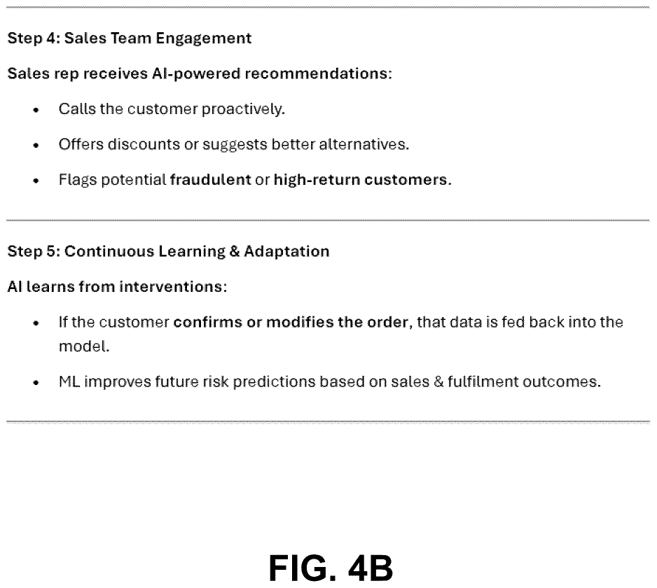

Additional machine learning aspects of illustrative embodiments will now be described with reference to FIGS. 3 and 4. Although these embodiments are described in conjunction with use cases involving interactions between sales teams and customers, the disclosed techniques can be readily adapted for utilization in numerous other use cases.

FIG. 3 includes multiple figures denoted as FIGS. 3A through 3C that show example pseudocode for implementing at least portions of an automated prediction and intervention system in an illustrative embodiment. For example, the pseudocode of FIG. 3 may be used to implement at least portions of automated prediction and intervention system 112 of FIG. 1, which illustratively comprises data preprocessing and variable encoding logic 114 and proactive machine learning system 116 comprising machine learning based prediction logic 118 and machine learning based intervention logic 120. More particularly, the various logic instances 114, 118 and 120 in the FIG. 1 embodiment are illustratively implemented as corresponding portions of the example pseudocode of FIG. 3. The example pseudocode of FIG. 3 is illustratively written in Python and is configured to utilize open-source machine learning libraries, although it is to be appreciated that other machine learning model creation, training and execution arrangements could be used in other embodiments.

The FIG. 3 embodiment implements first and second machine learning models of the type described previously. In this embodiment, the first machine learning model illustratively comprises a random forest classifier, and the second machine learning model illustratively comprises a generative AI model such as ChatGPT, although it is to be appreciated that any of a wide variety of other types of machine learning models can be used, as well as combinations of multiple such models. The term “machine learning model” as used herein is therefore intended to be broadly construed, and in some embodiments can comprise a combination of multiple distinct machine learning models of different types.

Referring to FIG. 3A, a number of Python libraries are initially imported, along with machine learning functions from scikit-learn (“sklearn”), such as a train_test_split function, a label encoder, and a random forest classifier. The pseudocode of FIG. 3A loads order data from a designated file path, performs data cleaning and preprocessing, encodes categorical variables which illustratively include Partner ID, partner_type, preferred_product and product_Brand, and encodes a target variable relating to order success, illustratively a binary order_status variable in which successful orders are encoded as a 0 value and unsuccessful orders including returns, refunds and exchanges are encoded as a 1 value.

The pseudocode of FIG. 3B performs feature selection for independent (“X”) and dependent (“y”) variables as illustrated, performs a train-test split, trains the random forest classifier, and then evaluates the trained random forest classifier to determine its accuracy.

Referring now to FIG. 3C, the example pseudocode shown implements a function to identify high-risk orders and to intervene in those orders using the second machine learning model, illustratively an LLM such as ChatGPT. The LLM is triggered to generate a response for one or more users of the enterprise sales team, illustratively via an API that is provided with an API key, a model version identifier and one or more role designations for the second machine learning model, as shown. Finally, the pseudocode is configured to test intervention logic, illustratively using the first machine learning model, in order to generate a sales response based on the LLM intervention.

The FIG. 3 pseudocode may be viewed as collectively providing an illustrative example of an algorithm implemented in the automated prediction and intervention system 112 of the support platform 110, but other algorithms could be used in other embodiments. For example, additional or alternative code arrangements may be used to implement machine learning based prediction and intervention in other embodiments.

Referring now to FIG. 4, another example process for machine learning based proactive prediction and intervention in an illustrative embodiment. The process includes steps denoted as Step 1 through Step 3 shown in FIG. 4A, and Steps 4 and 5 shown in FIG. 4B. This example process generally provides AI-driven sales intervention, integrating multiple machine learning models to reduce order cancellations. More particularly, the example process of FIG. 4 predicts high-risk orders using historical data, and implements real-time intervention using AI-driven suggestions to sales team members, illustratively with automated customer outreach via chatbot or email, sales representative assistance with insights on past cancellations, and an adaptive learning loop to improve the operation of the system over time.

Step 1 includes order placement and preprocessing. For example, a customer places an order, and the system extracts order details, such as Partner ID, Region, Order Volume, Product Type and/or additional or alternative order details.

Step 2 includes machine learning based (“ML-based”) risk assessment. For example, the first machine learning model illustratively predicts the probability of order failure based on designated features including at least a subset of past cancellations, returns and refunds; customer profile and buying behavior; product category and previous fulfilment success; and seasonality and stock levels. The first machine learning model illustratively comprises a random forest classifier, although additional or alternative models can be used, including, for example, a GBM or other gradient boosting model such as XGBoost.

Step 3 includes AI-based intervention that is illustratively LLM-driven, illustratively using an LLM such as GPT-4 from OpenAI. For example, if the order is identified as a high-risk order, illustratively by having a failure probability greater than a designated threshold percentage, the LLM generates real-time alerts with suggested actions. These may include one or more of the following:
1. For Sales Team: “Customer has a 75% chance of order failure. Contact the customer to verify stock availability.” One or more such communications can be integrated with CRM systems such as Salesforce, HubSpot and/or internal tools of the enterprise.
2. For Customer: Automated chatbot and/or email: “Hi [Customer Name], we noticed your order might have an issue. Can we help with alternatives?” For example, the communications may suggest bundled offers or alternate stock keeping units (SKUs) if stock in one or more ordered SKUs is low. One or more such communications can use web-based APIs such as Twilio, SendGrid and/or WhatsApp Business API.
3. For Logistics: Priority fulfilment or stock reallocation.

Step 4 includes sales team engagement, where one or more sales representatives (“reps”) on the sales team receive AI-power recommendations, which may direct a given sales representative to call the customer proactively, to offer discounts and/or to suggest better alternatives. Additionally or alternatively, it may flag potential fraudulent or high-return customers.

Step 5 includes continuous learning and adaptation. The AI learns from the automatically-generated interventions as described above. For example, if the customer confirms or modifies the order, that data is fed back into one or more of the machine learning models, so as improve future risk predictions based on sales and fulfilment outcomes.

The example process of FIG. 4 combines machine learning based predictions with LLM-driven interventions. Such an arrangement provides a proactive approach that can predict and prevent order cancellations before they happen. It illustratively uses multi-channel communication to automatically engage sales teams and customers, and implements real-time adaptation to provide continuous improvement through feedback loops.

Again, the forgoing arrangements are just examples, and should not be construed as limiting in any way. For example, additional or alternative steps can be used in other embodiments, possibly arranged in an order different than that shown above, and certain steps although arranged serially above may instead at least partially overlap with one another in other embodiments.

It is to be appreciated that the particular functionality, features and advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning based proactive prediction and intervention will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing system 100 in FIG. 1. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. A hypervisor platform may be used to implement a hypervisor within the virtualization infrastructure 504, where the hypervisor platform has an associated virtual infrastructure management system. The underlying physical machines may comprise one or more distributed processing platforms that include one or more storage systems. The VMs can implement at least portions of the automated prediction and intervention system 112 of support platform 110 in illustrative embodiments.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system. Such containers can implement at least portions of the automated prediction and intervention system 112 of support platform 110 in illustrative embodiments.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 612 may comprise random access memory (RAM), read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning based proactive prediction and intervention as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, support platforms, logic instances, machine learning models, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to maintain a plurality of data structures characterizing interactions between users of a plurality of devices in information technology infrastructure;
to obtain information characterizing an additional interaction between particular ones of the users of at least a subset of the devices in the information technology infrastructure;
to apply at least portions of the obtained information characterizing the additional interaction to a first machine learning model, wherein the first machine learning model is trained utilizing at least portions of the data structures to predict a particular one of a plurality of possible outcomes for the additional interaction;
responsive to the prediction of the particular outcome, to trigger at least a second machine learning model, different than the first machine learning model, to generate one or more communications for delivery to one or more of the devices, the one or more communications providing at least a portion of at least one interventive interaction targeted at achieving an actual outcome that is different than the predicted outcome; and
to cause the one or more communications to be transmitted to the one or more devices over at least one network.

2. The apparatus of claim 1 wherein the first machine learning model comprises at least one of a random forest classifier and a gradient boosting machine.

3. The apparatus of claim 1 wherein the second machine learning model comprises a generative artificial intelligence model including at least one large language model (LLM).

4. The apparatus of claim 1 wherein triggering the second machine learning model comprises accessing a web-based instance of the second machine learning model via an application programming interface (API).

5. The apparatus of claim 4 wherein accessing the web-based instance of the second machine learning model via the API comprises providing the web-based instance of the second machine learning model with an API key, a model version identifier and one or more role designations for the second machine learning model.

6. The apparatus of claim 1 wherein the one or more communications generated by the second machine learning model include one or more messages comprising content generated by the second machine learning model in accordance with at least one role designated based at least in part on the particular outcome predicted by the first machine learning model.

7. The apparatus of claim 1 wherein the at least one processing device is further configured to perform at least one test of the interventive interaction utilizing the first machine learning model prior to causing the one or more communications to be transmitted to the one or more devices over at least one network.

8. The apparatus of claim 7 wherein the one or more communications are transmitted to the one or more devices responsive to the at least one test of the interventive interaction resulting in a test outcome that is different than the predicted outcome.

9. The apparatus of claim 1 wherein the one or more communications comprise at least one communication directed to a customer relationship management (CRM) system that triggers the CRM system to perform a particular operation as part of the interventive interaction.

10. The apparatus of claim 1 wherein the one or more communications comprise at least one communication directed to a logistics system that triggers the logistics system to perform a particular operation as part of the interventive interaction.

11. The apparatus of claim 1 wherein the additional interaction relates to a particular transaction and the particular outcome comprises an indication that the particular transaction has an above-threshold probability of failure.

12. The apparatus of claim 1 wherein the interactions characterized by the plurality of data structures comprise respective transactions and respective corresponding indications of success or failure of the transactions.

13. The apparatus of claim 1 wherein the at least one processing device is further configured:
to determine the actual outcome for the additional interaction based at least in part on the at least one interventive interaction; and
to update the first machine learning model utilizing the actual outcome and the at least one interventive interaction.

14. A computer program product comprising a non-transitory processor-readable storage medium having stored therein program code of one or more software programs, wherein the program code when executed by at least one processing device causes the at least one processing device:
to maintain a plurality of data structures characterizing interactions between users of a plurality of devices in information technology infrastructure;
to obtain information characterizing an additional interaction between particular ones of the users of at least a subset of the devices in the information technology infrastructure;
to apply at least portions of the obtained information characterizing the additional interaction to a first machine learning model, wherein the first machine learning model is trained utilizing at least portions of the data structures to predict a particular one of a plurality of possible outcomes for the additional interaction;
responsive to the prediction of the particular outcome, to trigger at least a second machine learning model, different than the first machine learning model, to generate one or more communications for delivery to one or more of the devices, the one or more communications providing at least a portion of at least one interventive interaction targeted at achieving an actual outcome that is different than the predicted outcome; and
to cause the one or more communications to be transmitted to the one or more devices over at least one network.

15. The computer program product of claim 14 wherein triggering the second machine learning model comprises accessing a web-based instance of the second machine learning model via an application programming interface (API).

16. The computer program product of claim 14 wherein the one or more communications generated by the second machine learning model include one or more messages comprising content generated by the second machine learning model in accordance with at least one role designated based at least in part on the particular outcome predicted by the first machine learning model.

17. A method comprising:
maintaining a plurality of data structures characterizing interactions between users of a plurality of devices in information technology infrastructure;
obtaining information characterizing an additional interaction between particular ones of the users of at least a subset of the devices in the information technology infrastructure;
applying at least portions of the obtained information characterizing the additional interaction to a first machine learning model, wherein the first machine learning model is trained utilizing at least portions of the data structures to predict a particular one of a plurality of possible outcomes for the additional interaction;
responsive to the prediction of the particular outcome, triggering at least a second machine learning model, different than the first machine learning model, to generate one or more communications for delivery to one or more of the devices, the one or more communications providing at least a portion of at least one interventive interaction targeted at achieving an actual outcome that is different than the predicted outcome; and
causing the one or more communications to be transmitted to the one or more devices over at least one network;
wherein the method is performed by at least one processing device comprising a processor coupled to a memory.

18. The method of claim 17 wherein triggering the second machine learning model comprises accessing a web-based instance of the second machine learning model via an application programming interface (API).

19. The method of claim 17 wherein the one or more communications generated by the second machine learning model include one or more messages comprising content generated by the second machine learning model in accordance with at least one role designated based at least in part on the particular outcome predicted by the first machine learning model.

20. The method of claim 17 further comprising:
determining the actual outcome based at least in part on the at least one interventive interaction; and
updating the first machine learning model utilizing the actual outcome and the at least one interventive interaction.
